(19) United States
(12) Patent Application Publication
(10) Pub. No.: US 2009/0020504 A1
(43) Pub. Date: Jan. 22, 2009

(54) Method for manufacturing ink-jet head

(75) Inventors: Young-Seuck Yoo, Seoul (KR); Jae-Woo Joung, Suwon-si (KR); Won-Chul Sim, Seongnam-si (KR); Young-Jae Kim, Suwon-si (KR); Chang-Sung Park, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO.,LTD., Suwon (KR)

(21) Appl. No.: 12/153,017

(22) Filed: May 12, 2008

(30) Foreign Application Priority Data
Jul. 16, 2007 (KR) 10-2007-0071026

(51) Int. Cl. G11B 5/127

(52) U.S. Cl. 216/27

(57) ABSTRACT

A method for manufacturing an ink-jet head is disclosed. The method for manufacturing an ink-jet head including a chamber containing an ink, a reservoir connected with the chamber and supplying the ink to the chamber, a restrictor connected with the chamber and the reservoir and controlling a flow of the ink, a nozzle connected with the chamber and jetting the ink, and a channel connecting the nozzle to the chamber, may include: forming the chamber, the reservoir, the restrictor and the channel by etching a portion of a substrate; covering the chamber; and bonding a nozzle plate, in which a nozzle is formed, to the substrate such that the channel is covered. Using this method, the various structures of the ink-jet head may be formed by etching a substrate, whereby the process may be simplified, and the yield and reliability of the products can be improved.

### CROSS-REFERENCE TO RELATED APPLICATIONS

This application claims the benefit of Korean Patent Application No. 10-2007-0071026 filed with the Korean Intellectual Property Office on Jul. 16, 2007, the disclosure of which is incorporated herein by reference in its entirety.

### BACKGROUND

1. Technical Field

The present invention relates to a method for manufacturing an ink-jet head.

2. Description of the Related Art

An ink-jet head is an apparatus for jetting droplets through a nozzle by transforming electric signals to physical forces. According to the related art, ink-jet heads are manufactured by bonding individual structures for each function that are made from two or three wafer plates.

However, with an increase in the number of functions added, the thicknesses of the wafer plates have decreased, which has given rise to defects caused by wafers breaking during the manufacturing process. Also, because of a need for chambers having small volumes, very thin wafers are being used.

Thus, the method of forming the individual structures separately and then bonding them together, according to the related art, may not be suitable for increasing yield, and may also lower the reliability of the products.

### SUMMARY

An aspect of the invention is to provide a method for manufacturing an ink-jet head, which improves yield and increases the reliability of the product.

One aspect of the invention provides a method for manufacturing an ink-jet head including a chamber containing an ink, a reservoir connected with the chamber and supplying the ink to the chamber, a restrictor connected with the chamber and the reservoir and controlling a flow of the ink, a nozzle connected with the chamber and jetting the ink, and a channel connecting the nozzle to the chamber. The method includes: forming the chamber, the reservoir, the restrictor and the channel by etching a portion of a substrate; covering the chamber; and bonding a nozzle plate, in which a nozzle is formed, to the substrate such that the channel is covered.

The substrate may be an SOI (silicon on insulator) substrate consisting of a first silicon layer, a second silicon layer and an insulating layer interposed in-between. Here, a thickness of the first silicon layer may be in correspondence with a depth of the reservoir. Additionally, an operation of polishing at least one of the first silicon layer and the second silicon layer may be performed.

Also, the operation of covering the chamber may include bonding a membrane to the substrate by SDB (silicon direct bonding).

The chamber may be formed by etching one side of the substrate, and the reservoir may be formed by etching the other side of the substrate. Also, the etching may be performed by RIE (reactive ion etching).

The nozzle plate may be made of a material that includes at least one of polymer, stainless steel and silicon.

Additional aspects and advantages of the present invention will become apparent and more readily appreciated from the following description, including the appended drawings and claims, or may be learned by practice of the invention.

### BRIEF DESCRIPTION OF THE DRAWINGS

FIG. 1 is a flowchart of a method for manufacturing an ink-jet head according to an embodiment of the present invention.

FIG. 2 is a cross-sectional view of an SOI substrate.

FIG. 3A, FIG. 3B, FIG. 3C, FIG. 3D, FIG. 3E, FIG. 3F, FIG. 3G, FIG. 3H, FIG. 3I, FIG. 3J, FIG. 3K, FIG. 3L, FIG. 3M, and FIG. 3N are cross-sectional views representing the processes in a method for manufacturing an ink-jet head according to an embodiment of the present invention.

FIG. 4 is a cross-sectional view of an ink-jet head according to another embodiment of the present invention.

### DETAILED DESCRIPTION

As the invention allows for various changes and numerous embodiments, particular embodiments will be illustrated in drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

The method for manufacturing an ink-jet head according to certain embodiments of the invention will be described below in more detail with reference to the accompanying drawings. Those components that are the same or are in correspondence are rendered the same reference numeral regardless of the figure number, and redundant explanations are omitted.

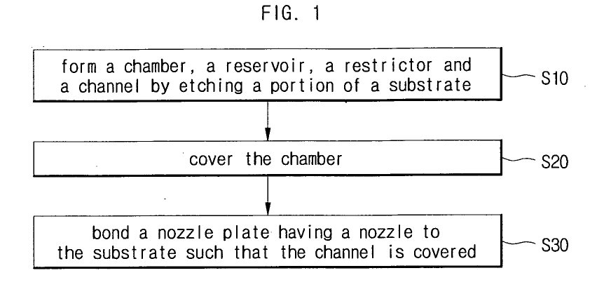

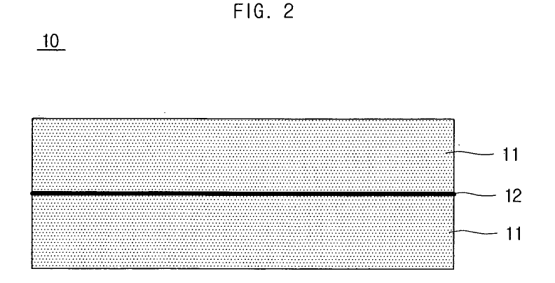

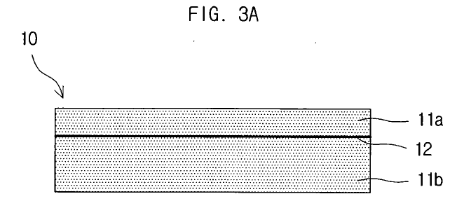

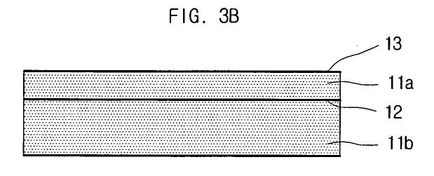

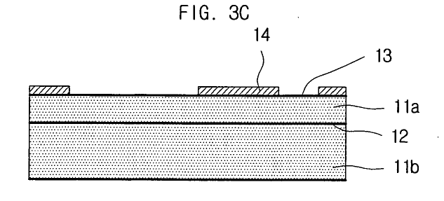

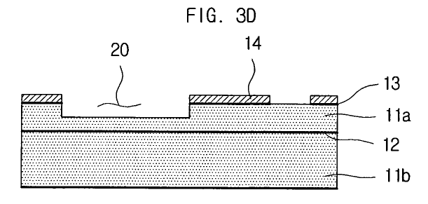

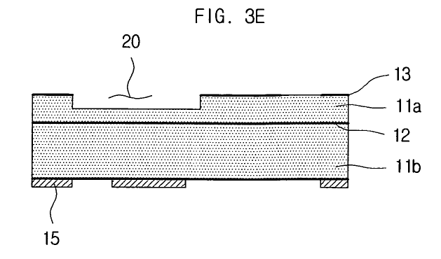

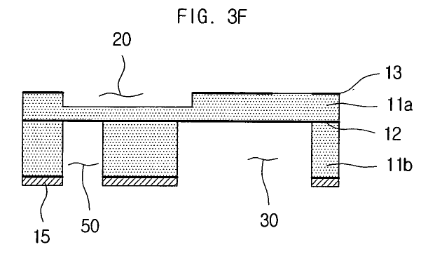

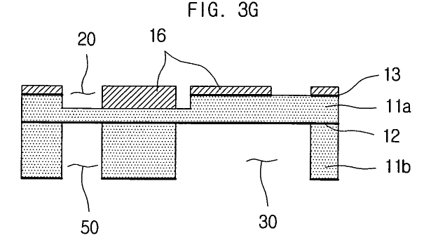

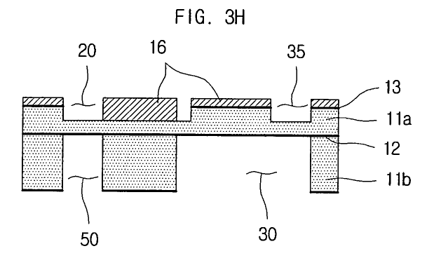

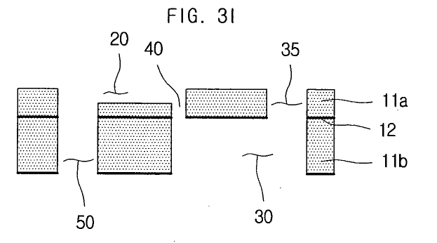

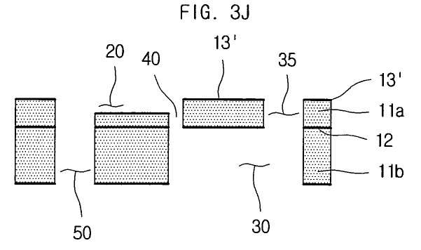

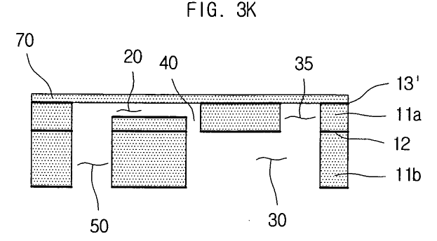

FIG. 1 is a flowchart of a method for manufacturing an ink-jet head according to an embodiment of the present invention, FIG. 2 is a cross-sectional view of an SOI substrate, and FIGS. 3A to 3N are cross-sectional views of the processes in a method for manufacturing an ink-jet head according to an embodiment of the present invention. In FIGS. 2 and 3, there are illustrated an SOI substrate 10, silicon layers 11, 11a, 11b, an insulating layer 12, a chamber 20, a reservoir 30, a restrictor 40, a channel 50, a nozzle plate 60, a nozzle 62, a membrane 70, and an actuator 80.

First, a chamber 20, a reservoir 30, a restrictor 40 and a channel 50 may be formed by etching a substrate (S110). Before describing the method for manufacturing an ink-jet head according to this embodiment, the various structures of the ink-jet head will be described below.

The chamber 20 may contain an ink, and the ink may be moved toward a nozzle 62 when a pressure is applied by an actuator 80. Then, the ink may be jetted.

The reservoir 30 may be supplied with the ink through an inlet 35, and may store the ink. Then, the reservoir 30 may provide the ink to the chamber 20.

The restrictor 40 may connect the reservoir 30 with the chamber 20, and control the amount of ink provided from the reservoir 30 to the chamber 20.

The channel 50 may connect the chamber 20 with the nozzle 62 such that the ink contained in the chamber 20 may be moved to the nozzle 62.

These structures may be formed by etching a substrate. Various wafers may be used as the substrate, but in this particular embodiment, an SOI substrate 10 may be used as the substrate. As illustrated in FIG. 2, the SOI substrate 10 may consist of two silicon layers 11 and an insulating layer 12 interposed between them. With reference to FIG. 3, a process of forming the structures by etching the SOI substrate 10 will be described below in further detail.

First, an SOI substrate 10 may be prepared (FIG. 3A) and a surface treatment may be applied to the SOI substrate 10. For the surface treatment, an oxide layer 13 may be formed on the SOI substrate 10 (FIG. 3B).

Meanwhile, the silicon layer 11 may be polished before the surface treatment. The polishing can be performed to control the thickness of the silicon layer, so that the silicon layer can be given a suitable thickness in consideration of the depths of the chamber 20, reservoir 30 etc. In the example shown in FIG. 3A, the upper silicon layer 11a is polished.

After the surface treatment, an etching resist 14 may be formed on an upper side of the SOI substrate 10 for forming the chamber 20 (FIG. 3C), and then the SOI substrate 10 may be etched (FIG. 3D). Since the shape of each structure is important in an ink-jet head, RIE (reactive ion etching) may be used for the etching, which can be advantageous in providing etching of a vertical shape.

After the chamber 20 is formed, an etching resist 15 may be formed on a lower side of the SOI substrate 10 for forming the reservoir 30 and the channel 50 (FIG. 3E), and then the SOI substrate 10 may be etched (FIG. 3F). The etching from the upper side for the chamber 20 and the etching from the lower side for the reservoir 30 allow for an easy manufacturing process.

In this case also, RIE (reactive ion etching) may be used for the etching, which can be advantageous in providing etching of a vertical shape, as for the process of forming the chamber 20.

Here, if the thickness of the lower silicon layer 11b is the same as the predetermined depth of the reservoir 30, the insulating layer 12 interposed between the silicon layers 11a, 11b may serve as a stopper in etching the SOI substrate for forming the reservoir 30. As such, controlling the depth may be facilitated, and the efficiency of the process may be increased. For this, a silicon layer having a thickness corresponding to the depth of the reservoir 30 may be prepared. The silicon layer may be prepared by polishing or various other methods.

Next, an etching resist 16 may be formed again on the upper side of the SOI substrate 10 (FIG. 3G) for forming the restrictor 40, which may connect the chamber 20 with the reservoir 30, and the inlet 35, through which ink may be supplied to the reservoir 30. Then, the SOI substrate 10 may be etched (FIG. 3H).

In manufacturing a piezoelectric ink-jet head such as in this embodiment, it is important to control the depth of the restrictor. Therefore, this embodiment, as already described above, may employ an SOI substrate 10, so that the insulating layer 12 interposed between silicon layers 11a, 11b may serve as a stopper. As a result, controlling the depth of the restrictor 40 may be facilitated, and the reliability of the product may be increased. In the example shown in FIG. 3I, the inlet 35 is connected with the reservoir 30, the reservoir 30 is connected with the chamber 20, and the chamber 20 is connected with the channel 50 by the etching. Next, the chamber 20 may be covered (S120). This can be to supply a pressure to the chamber 20 with an actuator 80. For this, an oxide layer 13′ may be formed on the upper side of the substrate (FIG. 3J), and a membrane 70 may be bonded onto the upper side of the substrate by SDB (silicon direct bonding) (FIG. 3K). If a vibration is generated by the actuator 80 formed on the membrane 70, a displacement of the membrane 70 may be generated by the vibration, and a pressure may be supplied to the chamber 20 by the displacement.

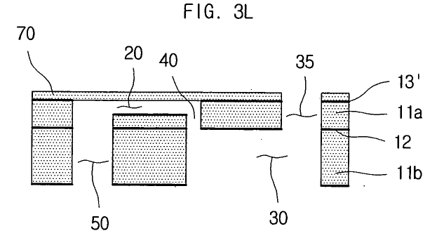

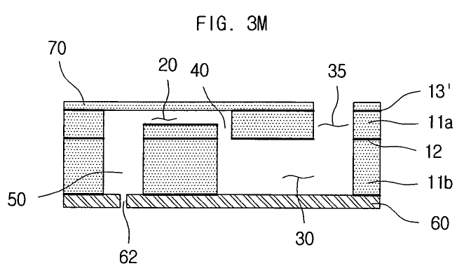

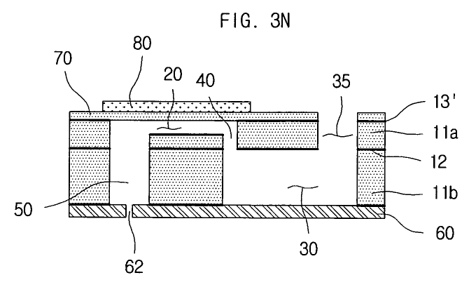

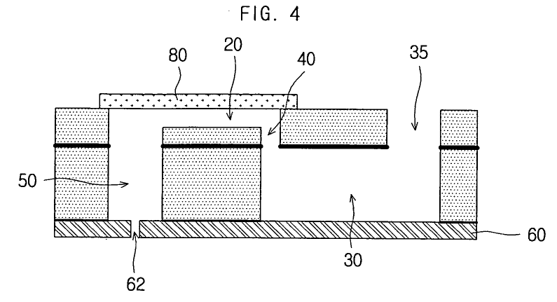

Meanwhile, in this embodiment, the membrane 70 may be used as a means to cover the chamber 20, but also the actuator 80 may cover the chamber 20 directly, as in the example shown in FIG. 4.

If the inlet 35 is stopped up by bonding the membrane 70 onto the upper side of the substrate, the inlet 35 may be opened again by removing a portion of the membrane 70 (FIG. 3L).

Next, a nozzle plate 60 may be bonded to the lower side of the substrate such that the channel 50 is covered (S130, FIG. 3M). As the nozzle plate 60 is bonded to the lower side of the substrate, the channel 50 and the reservoir 30 may be covered, facilitating the manufacturing process of the ink-jet head. Polymers, stainless steel (SUS), and silicon etc. can be used as the material for the nozzle plate 60.

Afterwards, an actuator 80 may be bonded onto the membrane (FIG. 3N).

As described above, in a method for manufacturing ink-jet head according to certain embodiments of the invention, the various structures of the ink-jet head may be formed by etching a substrate, whereby the process may be simplified, and the yield and reliability of the products can be improved.

While the present invention has been described with reference to particular embodiments, it is to be appreciated that various changes and modifications may be made by those skilled in the art without departing from the spirit and scope of the present invention, as defined by the appended claims and their equivalents. As such, many embodiments other than those set forth above can be found in the appended claims.

What is claimed is:

1. A method for manufacturing an ink-jet head comprising a chamber containing an ink, a reservoir connected with the chamber and supplying the ink to the chamber, a restrictor connected with the chamber and the reservoir and controlling a flow of the ink, a nozzle connected with the chamber and jetting the ink, and a channel connecting the nozzle to the chamber, the method comprising:
forming the chamber, the reservoir, the restrictor and the channel by etching a portion of a substrate;
covering the chamber; and
bonding a nozzle plate to the substrate such that the channel is covered, the nozzle plate having the nozzle formed therein.

2. The method of claim 1, wherein the substrate is an SOI (silicon on insulator) substrate comprising a first silicon layer, a second silicon layer and an insulating layer interposed in-between.

3. The method of claim 2, wherein a thickness of the first silicon layer is in correspondence with a depth of the reservoir.

4. The method of claim 2, further comprising:
polishing at least one of the first silicon layer and the second silicon layer.

5. The method of claim 2, wherein the covering comprises:
bonding a membrane to the substrate by SDB (silicon direct bonding)

6. The method of claim 1, wherein the chamber is formed by etching one side of the substrate, and the reservoir is formed by etching the other side of the substrate.

7. The method of claim 1, wherein the etching is performed by RIE (reactive ion etching).

8. The method if claim 1, wherein the nozzle plate is made of a material including at least one of polymer, stainless steel and silicon.
